(19) United States
(12) Patent Application Publication
(10) Pub. No.: US 2025/0263927 A1
(43) Pub. Date: Aug. 21, 2025

(54) WATERPROOF MEMBRANE

(71) Applicant: JOHNS MANVILLE, Denver, CO (US)

(72) Inventors: Jordan Kortmeyer, Parker, CO (US); Bradley Crume, Lakewood, CO (US); Jonas Houchin, Centennial, CO (US)

(21) Appl. No.: 18/442,773

(22) Filed: Feb. 15, 2024

(51) Int. Cl. E04D 5/06; C08L 23/16

(52) U.S. Cl. CPC E04D 5/06; C08L 23/16; C08L 2205/02

(57) ABSTRACT

A roofing and/or flashing membrane structure that includes a liquid polymer prior to cross-liking is disclosed. The roofing and/or flashing membrane may include additional polymers and have a multi-modal molecular weight distribution. The roofing system can have reduced tensile strength and increased elongation during installation but then strengthen on cross-liking.

### BACKGROUND OF THE INVENTION

Roofing membranes are commonly used for roofing systems of building and structures, for example in commercial building roofs. Roofing membranes are often applied to the building or structure's roof to prevent leaks and/or provide aesthetic appeal. Roofing membranes are commonly made of various synthetic rubber materials, modified bitumen, or thermoplastic materials. Certain elements of roofing structures, for example non-standard shapes, can require the application of flashing membranes to ensure that the roof remains waterproof. Thus, flashing membranes can be used field-fabricate a watertight seal around pipes, inside and outside corners, curbs and other roof details and penetrations, for example.

However, such roofing and flashing membranes can have rigidity and strengths that make them difficult to install and likely to thin when stretched. Therefore, improvements in the ease of installation of such membranes are desired.

### BRIEF SUMMARY OF THE INVENTION

Embodiments of the present technology may encompass materials, for example roofing materials, that include a liquid-containing roofing or flashing membrane. In some embodiments, the liquid may be a polymer that exists as a liquid when added to the composition. In some embodiments, the liquid may be a polymer that exists as or remains a liquid at installation conditions until the membrane is cross-linked (e.g., vulcanized or cured). The liquid may be, for example, an ethylene propylene diene terpolymer (EPDM). The membranes may include a second polymer, for example, an EPDM. The membranes may also include a third polymer, for example, an EPDM. The second and third polymers may be oil-extended or non-oil extended, for example one oil-extended EPDM and one non-oil extended EPDM. In some embodiments, the oil can be a heavy hydrotreated paraffinic oil. In some embodiments, the green strength of the membranes prior to cross-linking is less than or equal to 20 lbs force in both the machine direction and cross-machine direction. In some embodiments, the membranes have an elongation prior to cross-linking of 400 percent or higher in both the machine direction and the cross-machine direction. In some embodiments, the membrane does not meet the tensile strength requirements of ASTM 4811 (Standard Specification for Nonvulcanized (Uncured) Rubber Sheet Used as Roof Flashing) until after cross-linking.

Some embodiments of the present technology may encompass roofing membranes and flashing membranes that also comprise, a white clay, a white oil, or both. In some embodiments, the polymers of the membranes have crystallinities higher than 2 percent.

Some embodiments of the present technology may encompass a flashing membrane material with a first polymer that is a liquid as introduced, a second polymer, a tape or adhesive layer attached to the underside of the membrane, and a protective layer attached to the tape or adhesive layer on the opposite side as the membrane. The liquid first polymer may be, for example, an ethylene propylene diene terpolymer (EPDM) that is a liquid when added. The second polymer may be, for example, an EPDM. The membrane may also include a third polymer, for example, an EPDM. The second and third polymers may be oil-extended or non-oil extended, for example one oil-extended EPDM and one non-oil extended EPDM. In some embodiments, the green strength of the membranes prior to cross-linking is less than or equal to 20 lbs force in both the machine direction and cross-machine direction. In some embodiments, the membranes have an elongation prior to cross-linking of 400 percent or higher in both the machine direction and the cross-machine direction. In some embodiments, the membrane does not meet the tensile strength requirements of ASTM 4811 (Standard Specification for Nonvulcanized (Uncured) Rubber Sheet Used as Roof Flashing) until after cross-linking. In some embodiments, the flashing membrane may have a thickness between 5 mils and 30 mils.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a flashing membrane structure cross-section according to embodiments of the present invention.

FIG. 2 illustrates tensile strength data for comparative and inventive examples.

FIG. 3 illustrates elongation data for comparative and inventive examples.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Building and/or structure roofs, such as low slope or flat roofs for example, can be covered with waterproofing materials. For example, a “single ply” membrane can be used to waterproof a roof. A single ply membrane may be a large, flat, flexible membrane supplied on a roll. In use, the membrane is rolled out on top of the roof, for example on top of an insulation layer. The term “single-ply” is used herein to describe a roof having a single application of a membrane, but the membrane itself may comprise multiple layers such as polymer layers, reinforcing layers, adhesive layers, coatings, and the like. Base materials used for single ply membranes can include thermoplastic polyolefin (TPO), ethylene propylene diene monomer (EPDM), polyvinyl chloride (PVC), and modified bitumen, for example. In some embodiments, the membrane comprises TPO, EPDM, or combinations thereof.

In addition to waterproofing, such roofing membranes can be installed for various functional and/or aesthetic purposes. For example, roofing membranes may be installed to provide weather proofing, reduce urban heat island effects via heat reflection, reduce UV damage, reduce roof maintenance and/or degradation, improve weathering characteristics, and the like. Roofing membranes may also be used for aesthetic purposes, including providing a desired roof appearance, such as a uniform color or style.

Roofing systems can include flashing membranes, often in conjunction with the roofing membrane to waterproof certain sections of the roof structure such as pipes, inside and outside corners, curbs and other roof details and penetrations, for example. Thus, the flashing membranes can be used for scruppers and pipes (e.g., less than 1 inch diameter pipes), as examples. As used herein, the term “flashing membrane” and the like can be used to refer to both the flashing membrane itself as well as the entire flashing membrane structure (e.g., the flashing membrane itself and any additional layers and or materials, such as tape, adhesive layers, and/or protective layers) The flashing membrane can be designed to seal out water at the transition between roofing articles. In some embodiments, the flashing membrane is designed to be the outer sealing material, or the outer layer exposed to the elements.

Base materials used for flashing membranes can include thermoplastic polyolefin (TPO), ethylene propylene diene monomer (EPDM), polyvinyl chloride (PVC), and modified bitumen, for example. In certain embodiments, the base material for the flashing membrane is EPDM. In some embodiments, the flashing membrane comprises at least one liquid component. For example, in some embodiments, the flashing membrane comprises at least one polymer (for example, an EPDM polymer) that is reduced in viscosity by means of oil extension. In some aspects the viscosity can be reduced to a range of 20 to 50 Mooney Units (ML (1+4 @ 125° C.)) (e.g., from 25 to 50 Mooney Units or from 30 to 45 Mooney Units) by means of an oil extension. In other embodiments, the flashing membrane comprises at least one polymer (for example, an EPDM polymer) that is not oil extended but low enough in molecular weight such that it is liquid at processing temperatures (100,000-200,000 cps Brookfield Viscosity at 100° C. with a RVT #7 spindle). In further embodiments, the flashing membrane comprises both an oil-extended polymer and a non oil-extended polymer (e.g., an oil-extended EPDM and a non oil-extended EPDM). In additional embodiments, the flashing membrane comprises a combination of at least one non-oil extended polymer, at least one oil-extended polymer, and at least one liquid polymer. Thus, for example, the flashing membrane can comprise a combination of at least one non-oil extended EPDM polymer, at least one oil-extended EPDM, and at least one liquid EPDM polymer.

The liquid of the flashing membrane, in some embodiments, can be cross-linked (e.g., vulcanized, cross-linked, or cured) after application for example. In some instances, this can solidify the liquid. In some embodiments, cross-liking can occur by virtue of the flashing membrane composition having a diene component. In some embodiments, cross-linking can be achieved via accelerated sulphur vulcanization in some embodiments, co-agent-assisted peroxide cure is used for cross-linking. In other embodiments, activated resol cure can be used for dynamic vulcanization. The cross-linking can be initiated by methods such as adding heat, microwave radiation, or chemical initiation, for example.

Embodiments of the present invention can improve the pliability of the roofing systems, roofing membranes, and flashing membranes, for example, thereby improving the ease of installation while still maintaining the performance, e.g., the waterproofing performance. Embodiments of the present invention can have easier flex and bending, resulting in ease of use during application. Further, embodiments of the present invention can prevent thinning of the systems and membranes when stretched. Additionally, prior formulations in the art have used various oils, plasticizers, and/or low molecular weight components in an attempt to improve the flex and elongation of their products. These formulations can be problematic when used in conjunction with common roofing membranes such as thermoplastic polyolefin (“TPO”). TPO will swell (and lose integrity) when it comes into contact with standard formulations (such as EPDM) due to oil migration into the TPO. The formulations described herein have improved compatibility with TPO due in part to a lower oil content, and also provide improved oil compatibility (an overall more compatible system), thereby greatly reducing the tendency for any oil or material migration to TPO. This can be observed by laminating a flashing as described herein to the top surface of a TPO membrane and heat aging the composite either in direct sun exposure or in an oven above 130° F. and tracking the discoloration of the rear surface of the TPO. In some embodiments, a flashing according to the description herein shows no discoloration after being laminated to the top surface of a TPO membrane and heat aging the composite either in direct sun exposure or in an oven above 130° F.

In one embodiment, the green strength tensile strength of the system or membrane described herein can be 20 pounds force or less, e.g., from 20 lbs. force to 0.1 lbs. force, from 20 lbs. force to 1 lbs. force, from 18 lbs. force to 1 lbs. force, from 16 lbs. force to 1 lbs. force, from 15 lbs. force to 5 lbs. force, from 12 lbs. force to 8 lbs. force, or about 10 lbs. force. As used herein, the green strength can be the yield strength in the machine direction (“MD”), cross-machine direction (“CMD”), or both, as measured prior to cross-linking, vulcanization, or curing of the material, for example. In some embodiments, the green (yield) strength of the system or membrane during installation can be less than the ASTM 4811 final roof standard requirements until the material is cross-linked, cured, or vulcanized, at which point it exceeds the ASTM 4811 final roof standard requirements. Thus, in some embodiments, the system or membrane can be installed when flexible and then cross-linked, cured, or vulcanized when installed to increase the strength of the installed material. The cross-linking, curing, or vulcanization can be carried out through initiation, for example. In some embodiments, the cross-linking can be formed by chemical reactions that are initiated by heat, pressure, change in pH, or irradiation. In some embodiments, sulfur or peroxide can be added to the system or membrane to effect cross-linking.

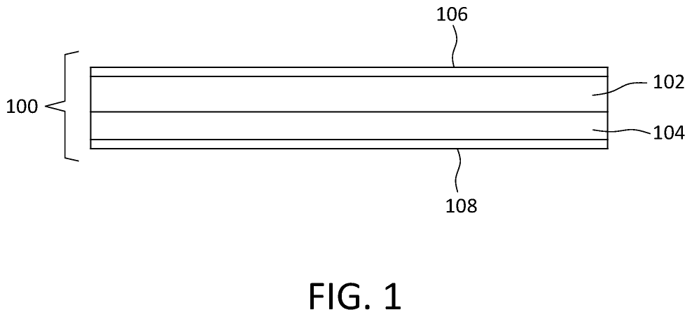

Turning now to FIG. 1, a cross-section of one embodiment of a flashing membrane structure 100 is illustrated. The flashing membrane structure can include a flashing membrane itself 102. In some embodiments, the flashing membrane 102 is a white flashing membrane. In other embodiments, the flashing membrane 102 is a black flashing membrane. The flashing membrane 102 can be made of a waterproof material such as TPO, EPDM, PVC, or modified bitumen, for example. In some embodiments, the flashing membrane 102 comprises TPO, EPDM, or combinations thereof. In some embodiments, the flashing membrane 102 comprises EPDM. In some embodiments, the flashing membrane comprises at least one liquid, such as a liquid EPDM at installation conditions (e.g, at standard conditions).

In some embodiments, the flashing membrane can comprise an oil-extended polymer (e.g., an oil extended EPDM). In other embodiments, the flashing membrane can comprise a non oil-extended polymer (e.g., an non oil-extended EPDM). If further embodiments, the membrane can comprise both an oil-extended polymer and a non oil-extended polymer (e.g., an oil-extended EPDM and a non oil-extended EPDM). In some embodiments, the membrane can comprise an oil-extended polymer, a non oil-extended polymer, and a liquid polymer (e.g., an oil-extended EPDM, a non oil-extended EPDM, and a liquid EPDM). In some embodiments, the flashing membrane polymers can have a multi-modal molecular weight distribution, for example a bi-modal or a tri-modal number average molecular weight distribution. In some embodiments, the flashing membrane 102 can have a bi-modal number average molecular weight distribution. In some embodiments, the flashing membrane 102 can have a tri-modal number average molecular weight distribution.

In some embodiments, the flashing membrane 102 may include one or more polymeric membranes and/or other waterproofing layers. For example, a polymeric membrane may form the outer layer of the flashing and/or the roof once fully installed and may help prevent leaks in the roofing structure and provide aesthetic appeal to the finished roof. For example, the waterproofing layer often provides a uniform outer surface that provides an aesthetically pleasing finished appearance to the roof. A polymeric flashing membrane 102 may have a white exterior but may be made in various other colors or shades, such as grey, tan, black, and the like. White polymeric membranes are often used to provide a pleasing appeal to the building and/or to reflect radiation and thereby minimize heat island effects. In other embodiments, a black or other dark polymeric membrane may be provided. Such polymeric membranes absorb more radiant heat than white polymeric membranes. Additionally, in the winter, condensation evaporates quicker and snow and ice melt more rapidly on black roofs than white roofs.

In some embodiments, polymeric membranes may be formed of various synthetic rubber materials, modified bitumen, or thermoplastic materials. For example, flashing membrane 102 may commonly include thermoplastic polyolefin (TPO), polyvinyl chloride (PVC), ethylene propylene diene monomer (EPDM), chlorinated polyethylene (CPA), and/or modified bitumen, although some embodiments may use other thermoset and/or thermoplastic roofing membranes. In some embodiments, the polymeric membrane may include one or more polymers blended with one or more fillers. For example, in some embodiments the polymeric membranes may include some combination of the following materials: polypropylene, polyethylene, block copolymer polypropylene, rubber, plasticizers, fiberglass, carbon fiber, fire retardants, and the like. In another embodiment, a polymeric membrane may have a more pure polymer blend without or with very few fillers. For example, the polymeric membrane may include mainly polypropylene or polyethylene or some combination of these polymers with little to no fillers, although in some embodiments, these polymeric membranes may include some amount of a filler, such as a fire retardant.

In some embodiments, the flashing membrane 102 may have a thickness of between about 500 μm to about 3 mm (e.g., from 500 μm to 3 mm, from 500 μm to 2 mm, or from 1 mm to 2 mm), however other thicknesses are possible in various embodiments.

In some embodiments, the flashing membrane 102 can comprise polymers that have a crystallinity of higher than 2 percent. In some embodiments, the flashing membrane 102 comprises only polymers that have a crystallinity of higher than 2 percent.

As shown in FIG. 1, the membrane can, in some embodiments, have a protective liner 106 attached to the membrane 102. The protective liner 106 can protect the membrane 102, for example prior to installation. The protective liner 106 can be positioned on the outer side or exterior of the membrane 102 (i.e. on the side of the membrane 102 exposed to the environment or the elements). In some embodiments, the protective liner 106 can be made of paper or a polymer film. In some embodiments, the protective liner 106 can be recyclable.

In certain embodiments, the flashing membrane structure 100 can include a tape or adhesive layer 104 attached to the membrane 102. The tape/adhesive layer 102 can be used to attach the membrane structure 100 to a roof structure, for example. In some embodiments, the tape/adhesive layer 104 can be positioned on the backside or underside of the membrane 102 (i.e., facing away from the environment or elements). In some embodiments, the tape/adhesive layer 104 directly contacts the membrane 102 (e.g., the backside of the membrane) while in other embodiments, there can be at least one layer between the membrane 102 and the tape/adhesive layer 104 (not shown). In some embodiments, the tape/adhesive layer 104 is a rubber tape, for example a butyl rubber tape. In some embodiments the tape/adhesive layer 104 is uncured. In some embodiments, the tape/adhesive layer 104 can be a white tape. In other embodiments, the tape/adhesive layer 104 can a black tape. In some embodiments, the tape/adhesive layer 104 can be a tape laminate. In some embodiments, the tape/adhesive layer 104 can be an adhesive laminate.

As shown in FIG. 1, the tape 104 can, in some embodiments, have a protective liner 108 attached to the tape 104. The protective liner 108 can protect the tape 104, for example prior to installation. In some embodiments, the protective liner 108 can cover an adhesive stuck to the tape 104. In some embodiments, the protective liner 108 can be positioned on the outer side or exterior of the tape 104 (i.e., the side of the tape 104 facing away from the membrane 102), such as a side of the tape 104 that contains an adhesive. In some embodiments, the protective liner 108 can be made of paper or a polymer film. In some embodiments, the protective liner 108 can be recyclable.

In other embodiments (not pictured), the membrane 102 may be secured to a roofing structure 100 using a thermoplastic film instead of the aforementioned tape 104. For example, a thermoplastic film may be positioned between the roofing structure and the membrane 102. Heat and/or pressure may be applied to the thermoplastic film upon being applied to the roofing structure and/or after applying the membrane 102 atop the thermoplastic film. The heat may cause the thermoplastic film to become tacky and stick to the roofing structure and the roofing membrane 102 to bond the roofing membrane 102 to the roofing structure. The thermoplastic film may be positioned proximate the edges of the membrane and/or may be positioned under medial portions of the membrane. In some embodiments, the thermoplastic film may be substantially coextensive with a bottom surface of the membrane 102 to help bond the entire surface of the membrane 102 to the roofing structure.

The thermoplastic film may have a thickness of between about 1 mil and 100 mils, between about 2 mils and 50 mils, between about 3 mils and 40 mils, between about 4 mils and 35 mils, or between about 5 mils and 30 mils. The thermoplastic film may have a substantially uniform thickness across the entire surface area of the thermoplastic film. For example, the thermoplastic film may have a thickness that is uniform to within 95%, to within 96%, to within 97%, to within 98%, to within 99%, or more across a surface of the thermoplastic film. Thermoplastic film may be activated by applying a sufficient amount of heat to tackify the thermoplastic film, which may often be between about 200° F. and 1148° F., although the exact temperature needed may depend on the composition of the thermoplastic film and/or a duration of time that the heat is applied to the thermoplastic film.

The thermoplastic film may be formed from various components, which may be selected based on the adhesive compatibility with the membrane 102. For example, in some embodiments, the thermoplastic film may be selected to have a base polymer that matches and/or has a same surface energy as a base polymer of the membrane 102. For example, if the membrane 102 is TPO, the thermoplastic film may include polypropylene. If the membrane 102 is PVC, the thermoplastic film may include polyurethane. If the membrane 102 is EPDM, the thermoplastic film may include polyethylene. Such pairings are merely meant as examples, and it will be appreciated that different formulations of thermoplastic films may be used with different compositions of membranes 102 in various embodiments. Additionally, the thermoplastic film may include polymers other than polypropylene, polyurethane, and polyethylene in various embodiments. In some embodiments, the thermoplastic film may provide a bond strength of between about 1 force pound and 50 force pounds (e.g., between 2 force pounds and 45 force pounds, between 3 force pounds and 40 force pounds, between 5 force pounds and 40 force pounds, or between 10 force pounds and 35 force pounds) using the ASTM D 1876 T-peel test.

In some embodiments, the membrane 102 can include further additives. For example, in some embodiments, the membrane 102 can comprise clay, such as a white clay. A commercial example is Polyfil 70. The per hundred resin (“PHR”) of the clay can range from 1 to 50, for example (e.g., from 1 to 40, from 5 to 30, from 10 to 30, from 15 to 25, or about 20, for example).

In some embodiments, the membrane can comprise an oil, such as a white oil. A commercial example is Paralux 6001. The PHR of the oil can range from 1 to 50, for example (e.g., from 1 to 40, from 5 to 35, from 10 to 30, from 15 to 30, or about 25, for example).

In some embodiments, the membrane 102 can comprise zinc oxide, for example for fire resistance, insect-proof, and fungistat properties. A commercial example is zinc oxide-85. The PHR of the zinc oxide can range from 0.1 to 30, for example (e.g., from 0.5 to 20, from 0.5 to 10, from 1 to 8, from 2 to 7, or about 5, for example).

In some embodiments, the membrane 102 can comprise stearic acid. The PHR of the stearic acid can range from 0.1 to 30, for example (e.g., from 0.5 to 20, from 0.5 to 10, from 1 to 5, from 1 to 4, or about 3, for example).

In some embodiments, the membrane 102 can comprise silica. A commercial example is Ultrasil D 7000. The PHR of the silica can range from 0.1 to 50, for example (e.g., from 1 to 40, from 5 to 40, from 10 to 35, from 15 to 30, or 20 to 30, for example).

In some embodiments, the membrane 102 can comprise silane. A commercial example is SCA 989 WT. The PHR of the silane can range from 0.1 to 25, for example (e.g., from 0.5 to 20, from 0.8 to 10, from 1 to 5, or from 1 to 3, for example).

In some embodiments, the membrane 102 can comprise talc. A commercial example is Mistron Vapor R. The PHR of the talc can range from 1 to 60, for example (e.g., from 10 to 50, from 20 to 55, from 25 to 50, from 30 to 45, or 40, for example).

In some embodiments, the membrane 102 can comprise titanium dioxide (TiO₂). A commercial example is TiPure R-105. The PHR of the TiO₂ can range from 1 to 60, for example (e.g., from 10 to 50, from 20 to 55, from 25 to 50, from 30 to 45, or 40, for example).

In some embodiments, the membrane 102 can comprise polyethene glycol (PEG). A commercial example is PEG 3350. The PHR of the PEG can range from 0.1 to 25, for example (e.g., from 0.5 to 20, from 0.8 to 10, from 1 to 5, or from 1 to 3, for example).

In some embodiments, the membrane 102 can comprise a process aid. A commercial example is Struktol TR 016. The PHR of the process aid can range from 0.1 to 30, for example (e.g., from 0.5 to 20, from 0.5 to 10, from 1 to 5, from 1 to 4, or about 3, for example).

In some embodiments, the membrane 102 can comprise polyethene (PE). A commercial example is PE AC617. The PHR of the PE can range from 0.1 to 30, for example (e.g., from 0.5 to 20, from 0.5 to 10, from 1 to 8, from 2 to 7, or about 6, for example).

In some embodiments, the membrane 102 can comprise a desiccant. A commercial example is Akrocal 80. The PHR of the desiccant can range from 0.1 to 30, for example (e.g., from 0.5 to 20, from 0.5 to 10, from 1 to 8, from 2 to 8, or about 7, for example).

In some embodiments, the membrane 102 can comprise sulfur. A commercial example is S-80. The PHR of the sulfur can range from 0.1 to 25, for example (e.g., from 0.5 to 20, from 0.8 to 10, from 1 to 5, or from 1 to 3, for example).

In some embodiments, the membrane 102 can comprise 80% MBS. A commercial example is S-80. The PHR of the 80% MBS can range from 0.1 to 25, for example (e.g., from 0.5 to 20, from 0.8 to 10, from 1 to 5, or from 1 to 3, for example).

In some embodiments, the membrane 102 can comprise zinc dibutyl dithiocarbamate (ZDBC). A commercial example is ZDBC-75. The PHR of the ZDBC can range from 0.1 to 25, for example (e.g., from 0.5 to 20, from 0.8 to 10, from 1 to 5, or from 1 to 3, for example).

In some embodiments, the membrane 102 can comprise a phenolic antioxidant. A commercial example is Irganox 1010. The PHR of the phenolic antioxidant can range from 0.1 to 25, for example (e.g., from 0.1 to 20, from 0.5 to 10, from 0.6 to 5, or from 0.6 to 1, for example).

In some embodiments, the membrane 102 can comprise at least one HALS stabilizer, for example two HALS stabilizers. Commercial examples are Tinuvin 770 and HA 88. The PHR of the HALS stabilizers can range from 0.1 to 25, for example (e.g., from 0.3 to 20, from 0.5 to 10, from 0.5 to 5, or from 1 to 3, for example).

In some embodiments, the membrane 102 can comprise a UV absorber. A commercial example is Tinuvin 329. The PHR of the UV absorber can range from 0.1 to 25, for example (e.g., from 0.2 to 20, from 0.3 to 10, from 0.4 to 5, or from 0.5 to 3, for example).

In some embodiments, the membrane 102 can comprise a phosphite antioxidant. A commercial example is Irgafos 168. The PHR of the phosphite antioxidant can range from 0.1 to 25, for example (e.g., from 0.3 to 20, from 0.4 to 10, from 0.5 to 5, or from 0.5 to 3, for example).

Also described is a method for installing a roofing membrane structure. The method may include providing a roofing membrane structure 100. The roofing membrane structure 100, as described in detail above and shown in FIG. 1, may be constructed from a flashing membrane itself. As stated above, the roofing membrane structure shown in FIG. 1 is merely exemplary and a variety of additional shapes and embodiments are envisioned and included within the scope of this disclosure. The flashing membrane can be made of a waterproof material such as TPO, EPDM, PVC, or modified bitumen, for example. In some embodiments, the flashing membrane comprises EPDM. In some embodiments, the flashing membrane comprises at least one liquid, such as a liquid EPDM at installation conditions (e.g, at standard conditions). In some embodiments, the flashing membrane can have a multi-modal (e.g., bi-modal or tri-modal) molecular weight distribution. The flashing membrane structure can include a tape attached to the membrane. The flashing membrane structure can also include at least one protective liner, such as a protective liner on the outer side of the membrane and a protective liner on the outer side of the tape.

The method may include providing a target object for flashing membrane structure application. The target object may be a non-standard shape on a roof that requires the application of flashing membranes to ensure that the roof remains waterproof. Thus the target object might be a pipe, a corners, a curbs, or other roof details and penetrations, for example. A target attachment surface may be defined on the target object and represents the position (which may include one or more entire surfaces) of the target object with which the flashing membrane structure is intended to cover.

In some embodiments, the method may include cleaning the attachment surface of the flashing membrane structure and/or cleaning the target attachment surface of the target object. In some applications or situations, the target object may have gathered dirt, dust, residual material from production, damage, or various other imperfections at the attachment surfaces. In some embodiments, a cleaning agent is applied to the target object and/or the flashing membrane structure to ensure a clean surface where the flashing membrane structure and/or the tape will be positioned and bonded. A washrag or an abrasive cleaning tool may be used by an installer in conjunction with the cleaning agent to apply additional abrasive forces to wipe or clean the attachment surface and/or the target attachment surface. It is envisioned that operation may include cleaning only a portion of or the entirety of the target object and/or the flashing membrane structure. Additionally, alternative cleaning methods known in the art made be used to clean one or more of the attachment surfaces.

The method may include flattening the flashing membrane structure by applying pressure to the flashing membrane structure. During shipping or manufacturing, the flashing membrane structure may be rolled up, folded, or experience other warping conditions (e.g., excessive heat, moisture, etc.) resulting in an uneven surface. In such cases, it may be beneficial to remove any distortions in the surface of the flashing membrane structure, and, to do so, mild heat and/or pressure may be applied to the flashing membrane structure, weighted pads, and/or other methods known in the art. For example, an applicator may be used to flatten the roofing membrane. Once flattened, the surface of the flashing membrane structure, particularly the attachment surface, will provide for a more consistent surface, allowing for a more accurate and consistent bond between the flashing material structure and/or the tape and the target. The application of mild heat during the flattening process may make the flashing membrane structure more pliable and may enhance the flattening process.

The method may include removing the protective liner, if any, from the outer surface of the tape and placing the tape of the flashing membrane structure at the attachment surface. As noted previously, during placement, the tape may, in some embodiments, be moved or repositioned without the thermoplastic film fusing, sticking, or securing to the attachment surface. However, in other embodiment the tape may not be repositioned once applied.

The method may include applying pressure to the flashing membrane structure once the tape is applied to the target object. The pressure may improve adhesion between the tape of the flashing membrane structure and the target object.

The method may include removing the protective liner, if any, from the outer surface of the flashing membrane.

The method may include cross-linking, curing, and/or vulcanizing the flashing membrane to increase the tensile strength of the flashing membrane and flashing membrane. In some embodiments, the tensile strength of the flashing membrane is increased through cross-linking, curing, and/or vulcanizing to meet the requirements of ASTM 4811.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of +20% or +10%, +5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of +20% or +10%, +5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

### Examples

A flashing membrane was prepared comprised of three types of EPDM. EPDM1 was an oil-extended EPDM. EPDM2 was a non oil-extended EPDM. The liquid EPDM was a liquid when added and at standard and installation conditions. The relevant components of the formulation (Example 1) is shown in Table 1 below.

TABLE 1
Example 1

| Raw Material | Per hundred resin (Phr) |
|---|---|
| EPDM1 (oil extended) | 15-30 |
| EPDM2 | 50-70 |
| Liquid EPDM | 15-35 |
| Silica | 20-40 |
| White clay | 10-30 |
| White oil | 15-30 |
| Sulfur | 0.5-2.0 |

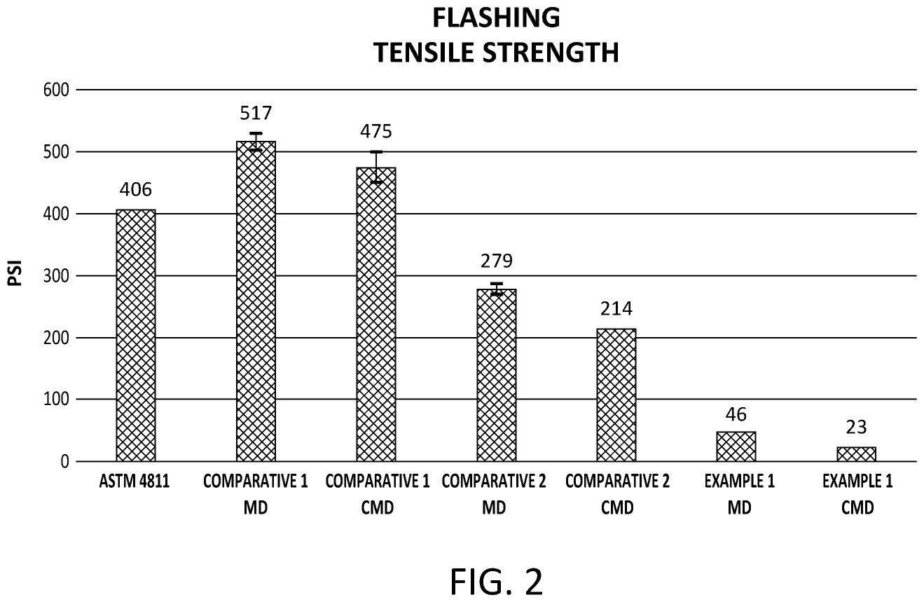

The tensile strength of the above Example 1 flashing membrane before vulcanization was measured along with the tensile strengths of two comparative sample commercial flashing membranes in both the machine and cross-machine directions according to ASTM 4811. The results are reported in FIG. 2. As can be seen from FIG. 2, the tensile strengths for Example 1 are much lower than the comparatives and the ASTM 4811. Without being bound by theory, this is what allows for the pliability and ease of installation of the inventive membranes.

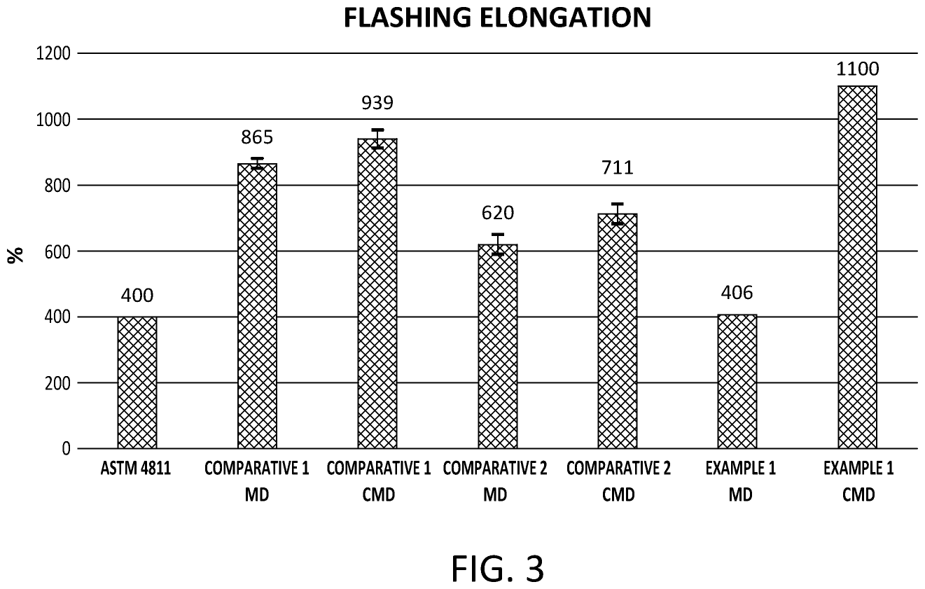

In addition, the elongation of the above Example 1 flashing membrane was measured before vulcanization along with the elongations of the two comparative sample commercial flashing membranes in both the machine and cross-machine directions according to ASTM 4811. The results are reported in FIG. 3. As can be seen from FIG. 3, the elongation for Example 1 prior to vulcanization exceeds the ASTM 4811 standard, especially in the cross-machine direction, where it demonstrates the highest elongation of any of the samples, resulting in significant flexibility for the inventive membranes during installation.

What is claimed is:

1. A membrane for roofing, comprising:
a first polymer that is a liquid as introduced into the membrane;
a second polymer; wherein
the green strength of the membrane prior to cross-linking is less than or equal to 20 lbs force in both the machine direction and the cross-machine direction.

2. The membrane for roofing of claim 1; wherein the second polymer is the same type as the first polymer.

3. The membrane for roofing of claim 1, wherein the first polymer is an ethylene propylene diene terpolymer (EPDM).

4. The membrane for roofing of claim 1, wherein the second polymer is an EPDM.

5. The membrane for roofing of claim 1, further comprising a third polymer.

6. The membrane for roofing of claim 5, wherein the third polymer is an EPDM.

7. The membrane for roofing of claim 1, further comprising a white clay.

8. The membrane for roofing of claim 1, further comprising a white oil.

9. The membrane for roofing of claim 1, wherein the membrane has an elongation prior to cross-linking of 400 percent or higher in both the machine direction and the cross-machine direction.

10. The membrane for roofing of claim 1, wherein the membrane does not meet the tensile strength requirements of ASTM 4811 until after cross-linking.

11. The membrane for roofing of claim 1, wherein the membrane is a flashing membrane.

12. The membrane for roofing of claim 6, wherein one of either the second polymer or the third polymer is an oil-extended polymer.

13. The membrane for roofing of claim 12, wherein one of either the second polymer or the third polymer is a non oil-extended polymer.

14. The membrane for roofing of claim 1, wherein the first and second polymers both have crystallinities higher than 2 percent.

15. A flashing membrane material, comprising:
a membrane comprising:
a first polymer that is a liquid as introduced into the membrane composition;
a second polymer;
a tape or adhesive layer attached to the underside of the membrane;
a protective layer attached to the tape on the opposite side as the membrane.

16. The flashing membrane material of claim 15, wherein the first polymer is an ethylene propylene diene terpolymer (EPDM).

17. The flashing membrane material of claim 16, wherein the second polymer is an ethylene propylene diene terpolymer (EPDM).

18. The flashing membrane material of claim 15, wherein the green strength of the membrane prior to cross-linking is less than or equal to 20 lbs force in both the machine direction and cross-machine direction.

19. The flashing membrane material of claim 15, further comprising a white clay and a white oil.

20. The flashing membrane material of claim 15, wherein the membrane does not meet the tensile strength requirements of ASTM 4811 until after cross-linking.
